(19) United States
(12) Patent Application Publication
(10) Pub. No.: US 2005/0156352 A1
(43) Pub. Date: Jul. 21, 2005

(54) Method of and apparatus for injection molding multicomponent fiber-reinforced molded parts

(75) Inventors: Erwin Burkle, Benediktbeuren (DE); Christoph Lange, Altomunster (DE); Heinz-Wolfgang Rasinger, Saxen (AT)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 11/013,208

(22) Filed: Dec. 15, 2004

Related U.S. Application Data
(63) Continuation of application No. PCT/EP03/06004, filed on Jun. 7, 2003.

(30) Foreign Application Priority Data
Jun. 21, 2002 (DE) 102 27 636.6

(51) Int. Cl. B29C 70/42; B29C 45/16

(52) U.S. Cl. 264/257; 425/573; 264/328.18

(57) ABSTRACT

To produce multicomponent molded plastic articles by injection molding, at least one component is manufactured using an injection molding compounder. A swivel platen machine with two working zones is used to produce multicomponent parts having cores or layers of fiber material or non-woven material. Fiber material may be shaped into a preform in a mold cavity in one working zone, and a preform that has been produced in a previous cycle is simultaneously encapsulated in or injected with plastic in the other working zone. The swivel platen is then rotated about its axis, transporting the preform from the one working zone into the other working zone, while the finished plastic article is removed.

### CROSS-REFERENCES TO RELATED APPLICATIONS

This application is a continuation of prior filed copending PCT International application no. PCT/EP2003/006004, filed Jun. 7, 2003, which designated the United States and on which priority is claimed under 35 U.S.C. §120, and which claims the priority of German Patent Application, Serial No. 102 27 636.6, filed Jun. 21, 2002, pursuant to 35 U.S.C. 119(a)-(d).

### BACKGROUND OF THE INVENTION

The present invention relates, in general, to a method of and apparatus for making multicomponent molded plastic articles.

Nothing in the following discussion of the state of the art is to be construed as an admission of prior art.

Examples of multicomponent molded plastic articles include oil pans with wrap-around seal for automobiles, housing lids with wrap-around seal, structural components with damping elements, multicolor components, or also structural components with a core or layer of fiber material, such as glass fibers or synthetic fibers, and a plastic body which has been molded thereon or encapsulated by injection molding.

German patent publication no. DE 198 48 246 describes a two-cycle injection molding process for making a multicomponent molded plastic article comprised of a thermoplastic part with injected elastomer seal. In a first cycle, a thermoplastic base body is produced in a mold with retractable cores, whereas in a second cycle, the cores are withdrawn and elastomer is injected into the thus-formed cavity.

International publication no. WO 01/10624 describes a so-called swivel platen machine having a moving platen, a fixed platen and a swivel platen disposed between the moving and fixed platens on a turntable for rotation. The swivel platen carries a half-mold on each side for interaction with a half-mold on the fixed platen and a half-mold on the moving platen, respectively. Associated to each of the fixed and moving platens is an injection unit. When the mold is closed, plastic material is injected in a first cycle into the cavity between the fixed platen and the swivel platen by an injection molding machine to thereby produce an injection-molded blank. Thereafter, the mold is opened and the swivel platen is rotated by 180° for transferring the blank to the moving platen. After closing the mold again, plastic material is injected in a second cycle by a second injection molding machine into the cavity between the moving platen and the swivel platen with contained blank, while the first cycle starts again.

Only single-phase or “pure” plastic material is processed in the afore-mentioned methods of making a multicomponent plastic article

German patent publication no. DE 114 22 29 describes an injection molding compounder having an extruder for plasticizing plastic material, and an injection cylinder receiving from the extruder via a pressure accumulator the plastic melt which is subsequently injected into a molding tool.

For reasons of stability and for cost reasons, there is increasingly a demand for providing carbon fiber reinforced or glass fiber reinforced plastics with possible other fillers. It would therefore be desirable and advantageous to provide an improved method and apparatus for making a multicomponent plastic article with at least one component containing a reinforcing material.

### SUMMARY OF THE INVENTION

According to one aspect of the present invention, a method of making a multicomponent plastic article through a multi-stage injection molding process, with at least one component made of a multiphase plastic mass comprised of plastic material and an additive, includes the steps of compounding plastic material in an extruder with an additive for making a multiphase plastic mass; and injecting the plastic mass via an injection unit into an injection mold.

The present invention resolves prior art shortcomings by producing in an extruder a multiphase plastic mass, for example through adding glass fiber material, carbon fiber material, mixing system or fillers, for making highly filled molded masses which is then used as a component in an injection molding process for making multicomponent plastic articles. Other materials may also be mixed and injected by an injection molding compounder or other injection molding units. Examples of further components include elastomer in the form of cross-linked plastics, rubber or liquid silicone rubber (LSR) or thermoplastic elastomer.

According to another feature of the present invention, two injection molding compounders (“in-mold compounders”) can be used for making two multiphase plastic masses to mold a multicomponent plastic article comprised of two components containing additive. Thus, molded plastic articles may, for example, be produced with a core or layers of fiber material in an injection molding machine having two working zones, preferably through integration of a swivel platen. In the first working zone, fibrous starting material is molded to a preform, while at the same time the second working zone subjects a previously produced preform to an injection molding process, i.e. plastic is molded on or around the preform. Thereafter, the finished plastic product is extracted from the second working zone, while the preform produced in the first working zone is transported by the swivel platen to the second working zone.

According to another aspect of the present invention, an apparatus for making a multicomponent plastic article through a multi-stage injection molding process with at least one component made of a multiphase plastic mass comprised of plastic material and an additive, includes a molding tool, a mold changing unit for subdividing the molding tool in working zones, with one of the working zone receiving and shaping a preform, and at least one injection molding unit interacting with the molding tool and constructed in the form of an extruder with an injection cylinder for compounding plastic material with an additive to provide an additive-containing plastic mass and injecting the plastic mass in another one of the working zones for subsequent production of a finished multicomponent plastic article in one of the working zones after suitable rotation of the mold changing unit.

In accordance with the present invention, it is now possible to integrate in a single machine the operations for producing a fiber-reinforced multicomponent plastic end product. Structural components can be made that meet highest mechanical standards.

Examples of starting material include in particular fabrics or non-woven material of glass fibers, natural fibers, carbon fibers or synthetic fibers, preferably in the form of an endless band. Thermoplastic is currently preferred as plastic material.

Swivel platen machines are suitable in particular for the use with two injection units. Such a configuration is desired to inject an additive during the second working zone in order to mold the preform. This additive may, for example, be a hardener to cure synthetic fibers, a binder to prevent the preform from swelling, when the injection mold is opened, a plastic material or material that enhances adhesion of the fiber material to the plastic being injected later.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of an injection molding machine for carrying out a process according to the present invention; and

FIG. 2 is a schematic block diagram of an exemplified injection molding unit of the injection molding machine of FIG. 1.

### DETAILED DESCRIPTION OF PREFERRED EMBODIMENTS

The depicted embodiment is to be understood as illustrative of the invention and not as limiting in any way. It should also be understood that the drawings are not necessarily to scale and that embodiments are sometimes illustrated by graphic symbols, phantom lines, diagrammatic representations and fragmentary views. In certain instances, details which are not necessary for an understanding of the present invention or which render other details difficult to perceive may have been omitted.

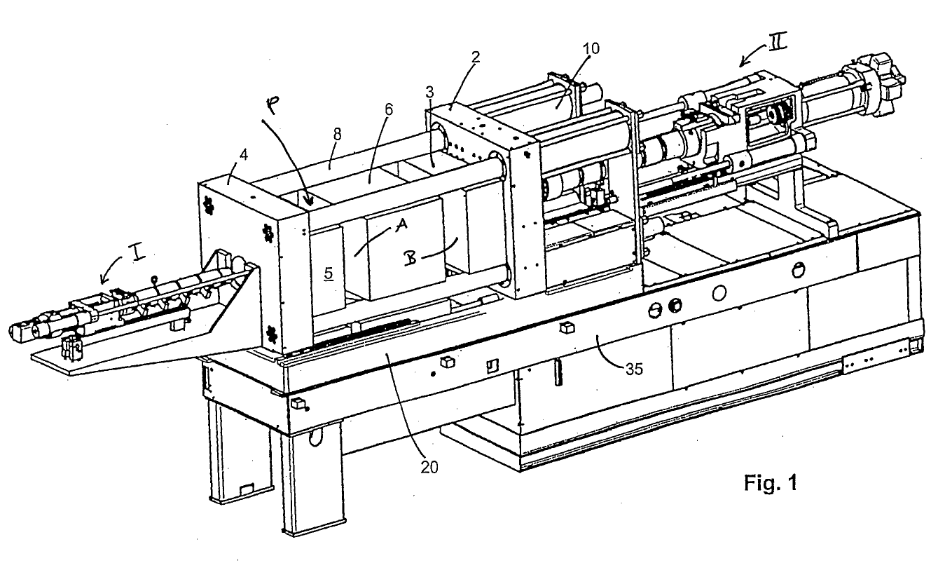

Turning now to FIG. 1, there is shown a perspective illustration of an injection molding machine including a fixed platen 2, which carries a half-mold 3, and a moving platen 4, which carries a half-mold 5. Placed between the half-molds 3, 5 is a swivel platen 6. The swivel platen 6, on one hand, and the half-molds 3, 5, on the other hand, are provided with, not shown, form recesses in confronting relationship to define respective cavities for injection molding plastic articles. Tie bars 8 extend through the fixed platen 2 for connection to the moving platen 4 which can thus be moved in the direction of and away from the fixed platen 2. Hydraulic cylinders 10 which form part of a drive mechanism, are shown for movement of the tie bars 8 and thus of the moving platen 4. Further shown is a first injection molding unit I (illustrated here only partially) and a second injection molding unit II, which will be described in more detail furtherbelow.

The entire construction of drive mechanism and platens 2, 4, 6 as well as injection molding units I and II is mounted on a module frame 20 which can be secured to a machine bed 35 of the injection molding machine.

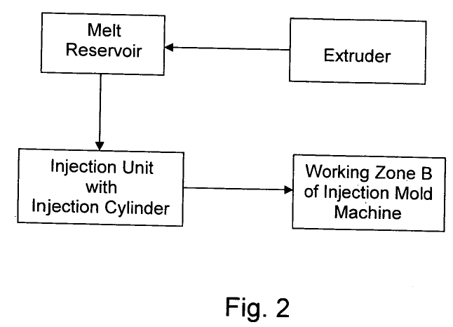

Defined between the moving platen 4 and the swivel platen 6 is a first working zone A, and between the swivel platen 6 and the fixed platen is a second working zone B. The second injection molding unit II is hereby constructed as an extruder in combination with an injection unit. FIG. 2 shows by way of example a schematic block diagram of the injection molding unit II, whereby the extruder compounds plastic material with an additive for making a multiphase plastic mass which is continuously fed to a melt reservoir for subsequent injection of the multiphase plastic mass into the cavity of the working zone B between the fixed platen 2 and the swivel platen 6 by a suitable injection unit with injection cylinder. Persons skilled in the art will understand that the melt reservoir may be realized as a unit separate from the extruder or may also be integrated into the extruder. Examples of an additive include glass fibers, glass globes, carbon fibers, and filler material. For sake of simplicity, the injection unit and melt reservoir are not shown in FIG. 1 in detail.

The injection molding unit I is shown here as an optional unit which can be constructed in a same manner as the injection molding unit I and may be used, if needed, to inject an additive, such as e.g. a hardener or binder, into the cavity of the first working zone A when producing a preform. Arrow P relates to the introduction of a fiber material, e.g. in the form of an endless band, via, for example, an unillustrated feeder into the working zone A.

The provision of the injection molding units I and II provides great versatility to produce various types of multicomponent plastic end products. Examples of various production processes will now be described in more detail.

### EXAMPLE 1

When the molding tools are open, fiber material can be introduced into the cavity of the first working zone A in the form of an endless band, as indicated by arrow P. After closing the molding tools through movement of the moving platen 4 and the swivel platen 6 in the direction of the fixed platen 2, the first working zone A produces a preform. At the same time, a finished article has been produced in the cavity of the second working zone B by molding multiphase plastic melt, which has been injected by the second injection unit II, around a previously produced preform.

Subsequently, the molding tools are opened again to allow removal of the finished plastic article from the working zone B, and to rotate the swivel platen 6 in order to transfer the preform, made in the working zone A, to the working zone B, while a further portion of fiber material is fed into the working zone A to start another operating cycle. This process results in a finished fiber-reinforced multicomponent plastic article.

### EXAMPLE 2

Similar to Example I with the difference residing in the involvement of the injection molding unit I which is now also operative to produce a multiphase preform which is comprised of fiber material that has been introduced into the working zone A and, before being transferred into the working zone B, is encapsulated or injected with plastic melt from the extruder of the injection molding unit I. Thus, the preform is an additive-containing fiber material. The thus produced preform is then transferred to the working zone B and molded with the injected multiphase plastic melt in working zone B, as described in Example 1.

### EXAMPLE 3

Another option involves the absence of introduction of fiber material and thus shaping of a preform in the working zone A only with plastic melt that has been produced and injected by the injection molding unit I, before being transferred to the working zone B and molded with the injected multiphase plastic melt in working zone B, as described in Example 1. The plastic mass injected into the working zone A by the injection molding unit I may be, e.g., elastomer in the form of cross-linked plastics, rubber or liquid silicone rubber (LSR) or thermoplastic elastomer to produce t a sealing ring, for example, which is injected into a fiber-reinforced oil pan molded in the working zone B.

### EXAMPLE 4

Similar to Example 3, with the difference residing in the operation of both injection molding units I and II as compounders. In other words, each of the injection molding units I and II produces an additive-containing plastic mass, with both additive-containing plastic masses combined in the working zone B to make a multicomponent plastic product.

### EXAMPLE 5

Similar to Example I, with the difference residing in the operation of the injection molding II to inject only a “pure” plastic mass without additive. The end product is a fiber material which is encapsulated by a plastic mass.

### EXAMPLE 6

Similar to Example 2, with the difference residing in the operation of the injection molding II to inject only a “pure” plastic mass without additive. The end product is an additive-containing fiber material which is encapsulated by a plastic mass.

### EXAMPLE 7

The injection molding I is operated to inject additive only into the working zone A which contains also fiber material. Thus, the preform is a fiber material with additive molded thereto. The injection molding unit II is operated to inject only a “pure” plastic mass without additive into the working zone B to make a multicomponent end product comprised of additive-containing fiber material encapsulated in a plastic mass.

Persons skilled in the art will understand that the sequence of operating steps may also be carried out in reverse sequence, i.e. the final multicomponent fiber-reinforced plastic article may be molded in the working zone A. In other words, the injection molding unit II is optional in this case, and the preform is shaped in the working zone B.

Although FIG. 1 shows the implementation of the injection molding units I and II in the form of extruders, each comprised of injection screw received in a barrel, it is, of course, conceivable to construct the injection molding units I and II instead of or in combination with injection molding compounders, also called in-mold compounders.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of making a multicomponent plastic article through a multi-stage injection molding process, with at least one component made of a multiphase plastic mass containing plastic material and an additive, said method comprising the steps of:
compounding plastic material in an extruder with an additive for making a multiphase plastic mass; and
injecting the plastic mass via an injection unit into a mold. (=Varianten a, b)

2. The method of claim 1, wherein two injection molding compounders are used for producing two multiphase plastic masses to make a multicomponent plastic article which contains two components mixed with an additive.

3. The method of claim 1, wherein the additive is at least one material selected from the group consisting of glass fibers, glass globes, carbon fibers, and filler material.

4. Apparatus for making a multicomponent plastic article through a multi-stage injection molding process with at least one component made of a multiphase plastic mass comprised of plastic material and an additive, said apparatus comprising:
a molding tool;
a mold changing unit for subdividing the molding tool in working zones, with one of the working zone receiving and shaping a preform; and
at least one injection molding unit interacting with the molding tool and constructed in the form of an extruder with an injection cylinder for compounding plastic material with an additive to provide an additive-containing plastic mass and injecting the plastic mass in another one of the working zones for subsequent production of a finished multicomponent plastic article in one of the working zones after suitable rotation of the mold changing unit.

5. The apparatus of claim 4, and further comprising a second said injection molding unit for introducing an additive-containing plastic mass into the one working zone so that the preform is a multiphase plastic mass.

6. The apparatus of claim 4, and further comprising a feeder for introducing a fiber material into the one working zone.

7. The apparatus of claim 6, wherein the fiber material is an endless band.

8. The apparatus of claim 7, wherein the endless band is a fabric made of a material selected from the group consisting of glass fiber, carbon fiber, natural fiber, and synthetic fiber.

9. The apparatus of claim 8, wherein the fabric is a non-woven.

10. The apparatus of claim 4, wherein the additive is at least one material selected from the group consisting of glass fibers, glass globes, carbon fibers, and filler material.

11. The apparatus of claim 4, wherein the additive is a hardener or a binder.

12. The apparatus of claim 4, wherein the injection molding unit is constructed as an injection molding compounder.

13. The apparatus of claim 4, wherein the mold changing unit is constructed to include movable cores to define a mold cavity of the molding tool.

14. The apparatus of claim 4, wherein the mold changing unit is constructed as a swivel platen.

15. Apparatus for making a multicomponent plastic article, said apparatus comprising:
a molding tool;
a mold changing unit for subdividing the molding tool in working zones, with one of the working zone receiving and shaping a fiber material; and
at least one injection molding unit interacting with the molding tool for producing a plastic mass and injecting the plastic mass in another one of the working zones for subsequent production of a finished multicomponent plastic article in one of the working zones after suitable rotation of the mold changing unit.

16. The apparatus of claim 15, wherein the injection molding unit is constructed as compounder for compounding the plastic mass with additive.

17. The apparatus of claim 15, and further comprising a second said injection molding unit for introducing an additive into the one working zone for molding onto the fiber material.

18. In combination:
an injection molding machine having a first working zone receiving and shaping a preform, and a second working zone; and
an extruder for compounding plastic material with an additive for making a multiphase plastic mass and injection into the second working zone for subsequent production of a finished multicomponent plastic article in one of the working zones.

19. The combination of claim 18, wherein the additive is at least one material selected from the group consisting of glass fibers, glass globes, carbon fibers, and filler material.

20. The combination of claim 19, and further comprising a further said extruder for compounding plastic material with an additive so as to produce a multiphase plastic mass for injection into the first working zone and subsequent shaping to the preform.

21. A method of making a mulitcomponent plastic article through a multi-stage injection molding process, with at least one component made of a fiber material, said method comprising the steps of:
introducing a fiber material into the cavity of a first working zone;
shaping the fiber material and forming a preform of fiber material; and
injecting a plastic mass onto or around said previously produced preform in a second working zone.

22. The method of claim 21, wherein the second plastic mass is a pure plastic mass.

23. The method of claim 21, wherein the second plastic mass is a multiphase plastic mass containing plastic material and an additive.

24. The method of claim 23, wherein the additive is at least one material selected from the group consisting of glass fibers, glass globes, carbon fibers, and filler material.

25. The method of claim 21, wherein an additive is injected into the cavity of the first working zone onto or around the preform of fiber material.

26. The method of claim 25, wherein the additive is a hardener or a binder.
